(19) United States
(12) Patent Application Publication
(10) Pub. No.: US 2005/0021373 A1
(43) Pub. Date: Jan. 27, 2005

(54) Apparatus for use in the medical field and method for its maintenance

(76) Inventor: Martin Spahn, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/886,344

(22) Filed: Jul. 7, 2004

(30) Foreign Application Priority Data
Jul. 7, 2003 (DE) 103 30 594.7

(51) Int. Cl. G06F 17/60

(52) U.S. Cl. 705/2

(57) ABSTRACT

In order to enable the remote maintenance of an x-ray system, the system or appertaining components are equipped with a wireless communication device that can be addressed by a maintenance center. A method is provided for generating data regarding an operating state of the apparatus by the apparatus; and transmitting the data to a maintenance center with a wireless communication device.

### BACKGROUND OF THE INVENTION

The invention concerns an apparatus for use in the medical field that comprises components to determine and produce data. The invention also concerns a method for maintenance of such an apparatus.

Such apparatuses are generally known. They can, for example, be apparatuses to acquire x-ray images for implementation of computer tomography, apparatuses for nuclear magnetic resonance, ultrasound apparatuses, or medical apparatuses used in the scope of nuclear medicine. In addition to apparatuses for medical diagnosis, therapy apparatuses such as accelerators are also used.

The design of these technical apparatuses used in the medical field is becoming increasingly more complex. The degree of complexity of the medical apparatuses continuously increases, particularly via the use of software to control the systems. Individual customer solutions are also possible via the use of software. It is common that different versions of complex medical apparatuses are in use at the different users.

In spite of the large complexity of the apparatuses used in the medical field, the requirements regarding interference resistance of these apparatuses are growing. On the one hand, the apparatuses should be optimally interruption-free when in the functioning state.

In the event that an error or a failure occurs, the error or the failure should be remedied as fast as possible. The data quantity necessary to analyze the failure can be very large under certain circumstances. In many cases, the error analysis cannot be implemented on site by a maintenance technician, but rather requires group of reserved specialists.

In the event of error or failure for such systems, until now a maintenance technician has been sent to the apparatus on site who then downloads the data necessary for analysis to a data medium. The data medium is then brought by the maintenance technician to a maintenance center. After an analysis of the data in the maintenance center, the maintenance technician must then remedy the error in a further site appointment. More than two site appointments for data acquisition are occasionally necessary. Under the circumstances, a lot of time passes until the apparatus is once again completely functional, which can lead to disgruntled customers.

### SUMMARY OF THE INVENTION

Starting from this prior art, the invention is based on the object to achieve an apparatus for use in the medical field that can be maintained in a simple manner. The invention is also based on the object of providing a method for maintenance of apparatuses in the medical field.

These objects are achieved by an apparatus for use in the medical field, comprising: components that determine and produce data; and a communication device for wireless transmission of the data to a maintenance center. These objects are further achieved by a method for maintaining an apparatus that can be used in the medical field, comprising: generating data regarding an operating state of the apparatus by the apparatus; and transmitting the data to a maintenance center with a wireless communication device.

These objects are achieved via an apparatus and a method with the features specified in the independent claims. Advantageous embodiments and developments are specified in the description below.

Various embodiments of the invention are discussed below. The apparatus for use in the medical field possesses a communication device for wireless transmission of data to the maintenance center. With the aid of the communication device, data can be directly exchanged between the communication device and the maintenance center without the site having to establish a fixed network connection. Rather, the communication device can be already completely parameterized and configured in the production of the medical apparatus in the factory.

It is also possible to initiate the transmission of the data necessary for error analysis immediately after the input of the error message without a maintenance technician having to be sent to the medical apparatus. Since no use of a maintenance technician is necessary for the transmission of data from the medical apparatus to the maintenance center, costs can be saved. Overall, the maintenance of the apparatuses in the medical field is more cost-effective and the reaction times are shortened.

In a further preferred embodiment, the apparatus possesses components that analyze data acquired in the operation of the apparatus and acquire error data provided for transmission. In such an embodiment, all of the data set present in the apparatus does not have to be transmitted to the maintenance center. This is particularly advantageous given image-processing apparatuses, since these devices frequently generate large quantities of data. Such large data quantities are not suited for transmission with the aid of wireless communication, at least not in uncompressed form.

In a further preferred embodiment, the medical apparatus can be calibrated with the aid of commands that can be transmitted from the maintenance center to the medical apparatus via the communication device. The medical apparatus can thereby be placed in a defined state suitable for the error analysis.

It is also possible to respectively associate a separate communication device for the wireless data exchange with the maintenance center with the individual components of the medical apparatus, such that the individual components can be directly addressed. This is particularly advantageous when individual components are frequently exchanged that must then be identified each time. The identity of the respective components is immediately assured via the communication devices integrated into the components, since each component can be directly addressed with an associated network address.

### DESCRIPTION OF THE DRAWINGS

The invention is subsequently explained in detail using the attached drawings described as follows.

FIG. 1 is a pictorial schematic illustrating a first exemplary embodiment of an x-ray system that is equipped with a communication device for wireless transmission of operation data to a maintenance center;

FIG. 2 is a pictorial schematic illustrating a further exemplary embodiment of such an x-ray system; and

FIG. 3 is a pictorial schematic illustrating a third, modified exemplary embodiment of such an x-ray system.

### DETAILED DESCRIPTION OF THE PREFERRED EMBODIMENTS

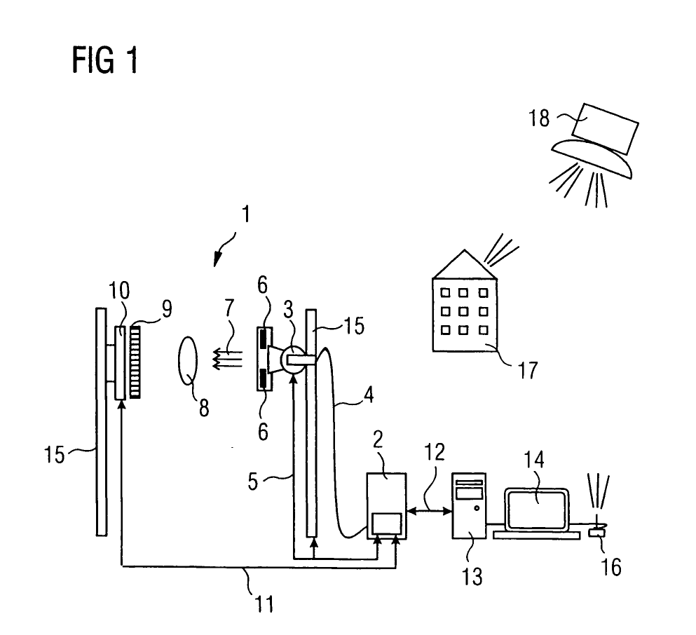

FIG. 1 shows a preferred embodiment having an x-ray system 1 that is operated with the aid of a control unit 2. The control unit 2 also comprises a generator to operate an x-ray radiator 3. The control unit 2 is connected with the x-ray radiator 3 via an energy supply cable 4 and a data line 5. Depth diaphragms 6 that serve to improve the optical imaging are arranged in front of the x-ray radiator 3. The x-ray radiator 3 generates x-ray radiation 7 that penetrates a subject 8 to be examined. The subject 8 to be examined can, for example, be a body part of a patient. The x-ray radiation 7 ultimately arrives through a scattered-ray grid 9 at a detector 10 where the x-ray radiation 7 is transduced into electrical charge. The charge quantity is thereby generally approximately proportional to the radiation energy incident during an exposure event.

In the x-ray system 1 shown in FIG. 1, the detector 10 can be a detector based on selenium or a solid-state detector, for example, a detector with optical coupling of an x-ray converter foil to a CCD or CMOS chip.

The data generated by the detector 10 can be transmitted via a data line 11 to the control unit 2 and from there via a bus line 12 to an image computer 13 with an observation monitor 14. The data supplied by the detector 10 are prepared in the image computer 13. For example, artifacts can be removed from the displayed image. In particular, image errors that are based on faulty pixels of the detector 10 can be eliminated via interpolation.

In addition to the use of various detector types for the detector 10, further variations are possible. For example, instead of the tripods 15 shown in FIG. 1, what is known as a C-arm can also be used to carry the x-ray radiator 3 and the detector 10.

In addition to mechanical modifications, individual adaptations are also possible in the programs to control the x-ray system 1 and the processing of the images acquired by the detector 10.

Due to the already complex structure of the x-ray system 1 and due to the different versions of the x-ray systems 1 found in use, it has therefore become increasingly difficult to service conventional systems. In particular, it is normally necessary to draw upon an entire group of specialists for error analysis upon the occurrence of an error function.

Thus, for example, unwanted image artifacts can appear when using the x-ray system 1. However, an error analysis can frequently not be executed by a technician on site. Rather, it is necessary to provide data regarding the function of the detector 10 to a group of specialists that are not normally located on site.

The x-ray system 1 therefore possesses a communication device 16 with which operating data can be transmitted from the x-ray system 1 to a maintenance center 17 in a wireless manner. In the exemplary embodiment of the x-ray system shown in FIG. 1, the wireless communication between the communication device 16 and the maintenance center 17 ensues with the aid of a satellite 18. In a modified embodiment, the data exchange between the x-ray system 1 and the maintenance center 17 ensues via a cellular mobile network. In the framework of this mobile network, the x-ray system 1 is assigned a fixed mobile number that can be dialed by the maintenance center 17.

In a preferred embodiment, the data transmission itself is executed with the aid of protocols of a packet-oriented telecommunication network. This embodiment offers the advantage that standardized and tested methods for transmission of data can be resorted to.

Since, given the use of wireless communication, existing bandwidth for transmission of information is limited, the x-ray system 1 can implement a calibration of the detector 10. During a calibration of the detector, for example, during a predetermined time span, the detector is irradiated with a specific x-ray radiation strength. The image acquired by the detector 10 is then compared with a desired image, and from this error data are acquired that are compressed and transmitted to the maintenance center 17.

In addition, it is possible in the operation of the x-ray system to store error protocols that are transmitted together with the error data, and possibly with the images disrupted by errors, to the maintenance center 17.

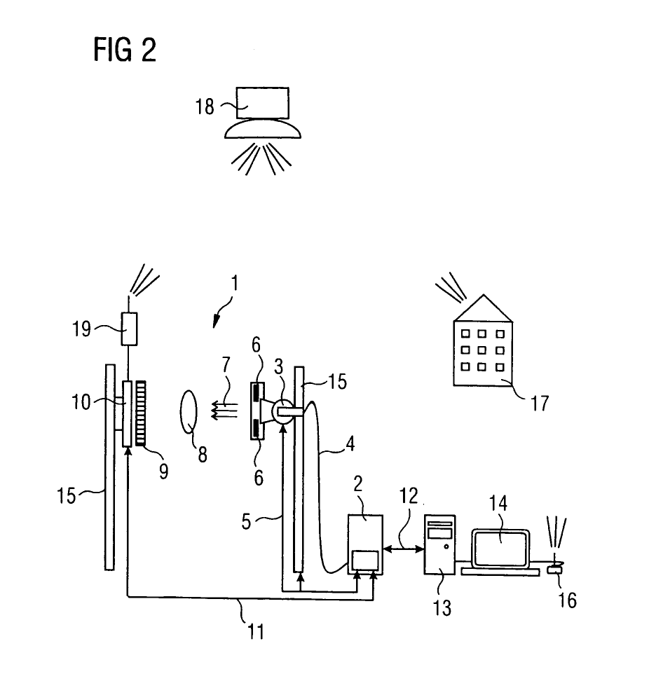

In FIG. 2, a further exemplary embodiment of the x-ray system 1 is shown in which the detector 10 itself possesses a communication device 19 with which data can be transmitted to a maintenance center 17 in a wireless manner. This is particularly advantageous when individual components have to frequently be separately identified.

In addition, it is also possible to assign an address to the individual components of the x-ray system 1, via which these components can be unambiguously identified. Thus, for example, even given an exchange of a component, a query by the maintenance center 17 can determine which components are located in the x-ray system 1.

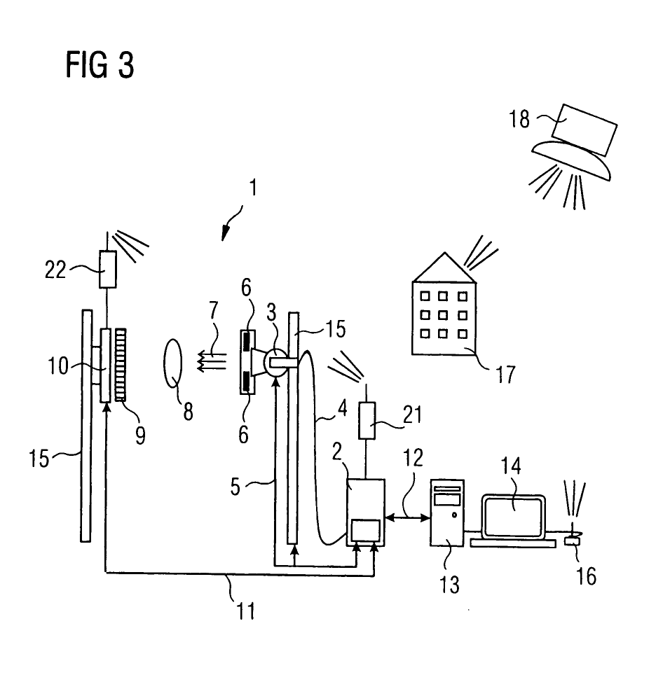

FIG. 3 finally shows an exemplary embodiment of the x-ray system 1 in which the communication between the components—in the case shown in FIG. 3, between the detector 10 and the control unit 2—likewise ensues in a wireless manner, for example, via radio according to the Bluetooth standard or via an infrared interface. For this purpose, communication devices 21 and 22 are respectively connected to the detector 10 and the control unit 2.

The exemplary embodiments of the x-ray system 1 shown in FIGS. 1 through 3 offer diverse advantages:

Via the communication devices 16 and 19 through 22, the x-ray system 1 or any components for which an error has been reported by the maintenance center 17 can specifically be addressed. The retrieval of the data necessary for analysis of the x-ray system 1 can immediately ensue after the notification of the error, since a technician does not have to be sent on site in order to acquire the necessary data, as required in the prior art.

The communication devices 16 and 19 through 22 can be configured and parameterized during the production of the x-ray system 1 in the factory. It is thus not necessary to establish a fixed network connection on site and to assign to the x-ray system 1 a telephone number for dial-up that must then be communicated by the telecommunication contractor to the maintenance center 17. Rather, the access data for the communication with the medical apparatus are known to the factory and can be stored in the maintenance center 17.

In the event that additional data must be generated by the x-ray system 1 for error analysis, these events can be initiated via commands transferred from the maintenance center 17. This is, for example, necessary when the individual detectors 10 of an x-ray system comprising multiple detectors must be examined regarding its functionality. The data generated by the detectors 10 are then frequently stored without a detector identifier in digital archives of the hospitals, such that a subsequently association of the images with a specific detector is impossible. When the x-ray system 1 is equipped with a plurality of the detectors 10, it can therefore be necessary to test out the individual detectors 10 in order to isolate the error.

The communication devices 16 and 19 through 22 are also of advantage given sporadically-occurring errors. A download of operating data of the x-ray system 1 can be triggered immediately after the occurrence of an error incident that, for example, is controlled by the control unit 2.

Via the remote maintenance possible in the x-ray systems 1, the use of technicians for the maintenance of the x-ray system 1 can largely be foregone. The shutdown of the x-ray system 1 while the technician extracts the data from the x-ray system 1 can be prevented.

In addition, it is also possible to repeatedly retrieve the data necessary for error analysis at periodic intervals in order to continuously monitor the x-ray system 1.

The concept of a remote maintenance specified here is not limited to x-ray systems. Rather, the concept for remote maintenance specified here can also be transferred to further medical apparatuses. For example, in addition to x-ray systems, an acoustic output signal that operates with computer tomography, nuclear magnetic resonance, ultrasound or radioactive radiation can be considered. Even therapy apparatuses, for example, accelerators, can advantageously also be equipped with communication devices for the wireless communication with a maintenance center 17.

It is also possible to equip the medical systems and apparatuses with communication devices that allow a position determination. In this manner, the locality can be determined given mobile systems and apparatuses, for example, mobile x-ray systems in buses, and the user or customer can be identified.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### Reference List

1 x-ray system

2 control unit

3 x-ray radiator

4 energy supply cable

5 data line

6 depth diaphragm

7 x-ray radiation

8 subject

9 scattered-ray grid

10 detector

11 data line

12 bus line

13 image computer

14 observation monitor

15 tripod

16 communication device

17 maintenance center

18 satellite

19 communication device

20 communication device

21 communication device

22 communication device

1. An apparatus for use in the medical field, comprising:
components that determine and produce data; and
a communication device for wireless transmission of the data to a maintenance center.

2. The apparatus according to claim 1, wherein the data transmission ensues with the aid of a mobile network.

3. The apparatus according to claim 2, wherein the apparatus is assigned a fixed network address.

4. The apparatus according to claim 1, wherein the communication device or an additional communication device is associated with at least one of the components of the apparatus.

5. The apparatus according to claim 4, wherein the at least one component has an associated fixed network address.

6. The apparatus according to claim 1, further comprising:
a unit configured to generate error data that describe the error functions of the apparatus, and via which the error data can be transmitted to the maintenance center.

7. The apparatus according to claim 6, further comprising:
a compression unit configured to compress the error data.

8. The apparatus according to claim 1 wherein the apparatus is configured to be calibrated via commands transferred from the maintenance center.

9. The apparatus according to claim 1, wherein communication devices configured for the wireless communication of the components among one another are associated with the components of the apparatus.

10. The apparatus according to claim 1, wherein the apparatus is an x-ray system.

11. A method for maintaining an apparatus that can be used in the medical field, comprising:
generating data regarding an operating state of the apparatus by the apparatus; and
transmitting the data to a maintenance center with a wireless communication device.

12. The method according to claim 11, further comprising:
repeating the transmitting of the data at periodic intervals.

13. The method according to claim 11, wherein data are transmitted to the maintenance center immediately after detecting an error.
